(19) United States
(12) Patent Application Publication
(10) Pub. No.: US 2023/0109617 A1
(43) Pub. Date: Apr. 6, 2023

(54) PRUNING HARDWARE UNIT FOR TRAINING NEURAL NETWORK

(71) Applicant: ALIBABA GROUP HOLDING LIMITED, Grand Cayman (KY)

(72) Inventors: Tianchan GUAN, Shanghai (CN); Yuan GAO, Shanghai (CN); Hongzhong ZHENG, Los Gatos, CA (US); Minghai QIN, Fremont, CA (US); Chunsheng LIU, Pleasanton, CA (US); Dimin NIU, Sunnyvale, CA (US)

(21) Appl. No.: 18/078,504

(22) Filed: Dec. 9, 2022

Related U.S. Application Data
(63) Continuation of application No. PCT/CN2020/095612, filed on Jun. 11, 2020.

(51) Int. Cl. G06N 3/082

(52) U.S. Cl. CPC G06N 3/082

(57) ABSTRACT

A system for pruning weights during training of a neural network includes a configurable pruning hardware unit that is configured to: receive, from a neural network training engine, inputs including the weights, gradients associated with the weights, and a prune indicator per weight; select unpruned weights for pruning; prune the unpruned weights selected for pruning; update the prune indicator per weight for the weights that are selected and pruned; and provide the updated prune indicator to the training engine for the next iteration or epoch. The pruning hardware unit can be configured to perform incremental pruning or non-incremental pruning.

### CROSS-REFERENCE TO RELATED APPLICATION

This application is a continuation of PCT/CN2020/095612 filed on Jun. 11, 2020 and titled “PRUNING HARDWARE UNIT FOR TRAINING NEURAL NETWORK”, the content of which is hereby incorporated by reference in its entirety.

### BACKGROUND

Neural networks are used to perform artificial intelligence (AI) tasks. A neural network is trained using a training dataset and, once trained, performs the AI task by mapping inputs to outputs. The training process involves finding and assigning weights to the neurons, or nodes, in the neural network that accurately accomplish the AI task. The training process is iterative, with the weights being updated during each iteration (e.g., each epoch) based on the results of the previous iterations.

Backward propagation (BP) algorithms are widely used during training of neural networks. In general, BP is used to determine and fine-tune the weights at the neurons of a neural network based on the magnitudes of errors calculated in a previous epoch (e.g., iteration). BP is well known in the art.

Training neural networks is resource-intensive and time-consuming. The amount of computational and storage resources and time required to train a neural network can be reduced without affecting the accuracy of the neural network, by careful pruning of data (e.g., weights) during the training process. Incremental pruning achieves a good balance between accuracy and computational overhead. However, conventional software-implemented incremental pruning cannot leverage the benefits of incremental pruning because: it needs to compute, store, and access all weights and their gradients; compute the pruning criteria of all weights of the neural network; and sort criteria for all weights of the neural network.

### SUMMARY

Disclosed herein is a system for pruning weights during training of a neural network. The system includes a configurable pruning hardware unit that is configured to: receive, from a neural network training engine, inputs including the weights, gradients associated with the weights, and a prune indicator per weight; select unpruned weights for pruning; prune the unpruned weights selected for pruning; update the prune indicator per weight for the weights that are selected and pruned; and provide the updated indicators to the training engine for the next iteration or epoch. The system can be used for incremental pruning as well as for non-incremental pruning.

In embodiments, the pruning hardware unit includes a weight criteria compute module that receives inputs from a neural network training engine. The inputs includes values of weights for nodes of the neural network and values of gradients. The inputs also include values of an indicator per weight, where the value of the indicator indicates whether the associated weight is a pruned weight or an unpruned weight. In some embodiments, the weight criteria may compute module outputs criteria of weights only for unpruned weights. The pruning hardware unit also includes a top-k module that computes a value of a pruning threshold based on the outputs of the weight criteria compute module. The pruning hardware unit also includes a prune module that updates the values of the indicator per weight and provides the updated values to the training engine.

In embodiments, the pruning hardware unit includes a number of registers that store values that configure the pruning hardware unit. The registers are configured by the training engine, and written to by an application programming interface that provides a software interface between the training engine and the pruning hardware unit. The registers include a software-enable register that, along with a hardware-enable signal from the training engine, enables the pruning hardware unit. A criterion register defines the criteria to be used to prune unpruned weights. An input selection register identifies the weights and gradients to take from the training engine. A mode register defines the pruning mode. In embodiments, there is an incremental pruning mode and a non-incremental pruning mode. The value in an N register is the number N of unpruned weights. The value in a k register is the number k of weights that are not to be pruned in the current iteration or epoch.

A pruning hardware unit in embodiments according to the disclosure avoids the aforementioned shortcomings of conventional software-implemented incremental pruning. Embodiments according to the disclosure reduce the amount of computational and storage resources and time required to train neural networks without affecting the accuracy of the neural networks, by careful pruning of data (e.g., weights) during the training process.

The above, and other, objects and advantages of the various embodiments of the present disclosure will be recognized by those of ordinary skill in the art after reading the following detailed description of the embodiments that are illustrated in the various drawing figures.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 shows a block diagram of an example of a system upon which the embodiments described herein may be implemented.

FIG. 2 is a block diagram illustrating a pruning hardware unit in embodiments according to the present disclosure.

FIG. 3 is a block diagram illustrating the weight criteria compute module in embodiments according to the present disclosure.

FIG. 4 is a block diagram illustrating the prune module in embodiments according to the present disclosure.

FIG. 5 is a flowchart of a method for training a neural network in embodiments according to the present disclosure.

### DETAILED DESCRIPTION

Reference will now be made in detail to the various embodiments of the present disclosure, examples of which are illustrated in the accompanying drawings. While described in conjunction with these embodiments, they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

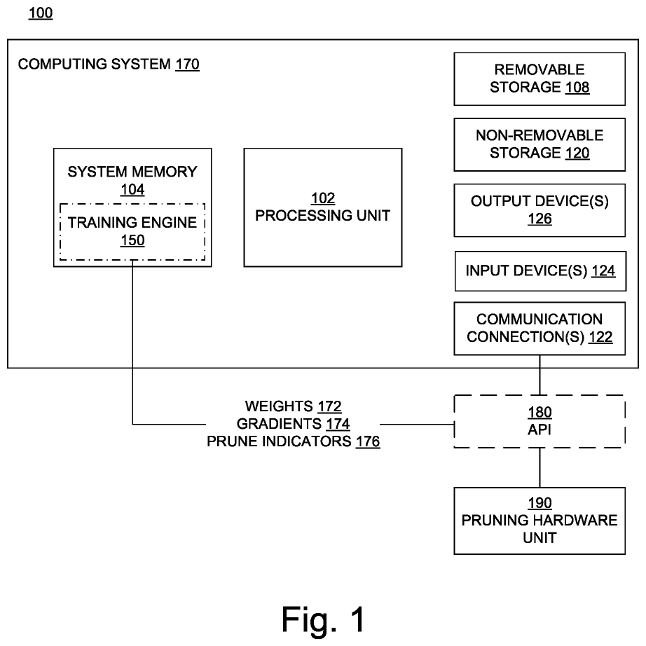

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “accessing,” “determining,” “storing,” “selecting,” “indicating,” “pruning,” “updating,” “setting,” “computing,” “multiplying,” “providing,” or the like, refer to actions and processes of an apparatus or computer system or similar electronic computing device or system (e.g., the system of FIG. 1). A computer system or similar electronic computing device manipulates and transforms data represented as physical (electronic) quantities within memories, registers or other such information storage, transmission or display devices.

Some elements or embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory (e.g., an SSD) or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

The discussion to follow includes terms such as “weight,” “gradient,” “prune indicator,” etc. Unless otherwise noted, a value is associated with each such term. For example, a weight has a value, and different weights can have different values. For simplicity, the term “weight” may refer to a value of a weight, for example, unless otherwise noted or apparent from the discussion.

FIG. 1 shows a block diagram of an example of a system 100 upon which the embodiments described herein may be implemented. In its most basic configuration, the system 100 includes a computing system 170 coupled to a pruning hardware unit 190.

The computing system 170 includes at least one processing unit 102 and at least one memory 104. Each processing unit 102 may be a general-purpose processor or a specialized processor such as a neural processing unit.

The computing system 170 may also have additional features and/or functionality. For example, the system 100 may also include additional storage (removable and/or non-removable). Such additional storage is illustrated in FIG. 1 by removable storage 108 and non-removable storage 120. The computing system 170 may also include one or more communications connections 122 that allow the computing system to communicate with other devices such as but not limited to the pruning hardware unit 190. The computing system 170 also includes input device(s) 124 such as keyboard, mouse, pen, voice input device, touch input device, etc. Output device(s) 126 such as a display device, speakers, printer, etc., may also be included.

In the example of FIG. 1, the memory 104 includes computer-readable instructions, data structures including databases, program modules, and the like associated with a training engine 150. The training engine 150 trains a neural network over multiple training iterations or epochs. In each iteration or epoch, the training engine 150 trains the neural network on a respective mini-batch of training data, each mini-batch consisting of tens to hundreds of samples of training data, for example. In general, the training engine 150 determines weights and gradients of an objective (loss) function that characterizes the accuracy of a neural network, and then uses that information to adjust the weights to improve the accuracy of the neural network. The training engine 150 may use, for example, backward propagation algorithms to determine and fine-tune the weights at the neurons (or nodes) of a neural network based on the magnitudes or absolute values of errors calculated in a previous epoch or iteration.

In embodiments according to the present disclosure, the computing system 170 outputs weights 172 and gradients 174 from the training engine 150 to the pruning hardware unit 190. In embodiments, a prune indicator 176 is associated with each weight. In embodiments, the prune indicator 176 is a one-bit value that indicates whether or not an associated weight is unpruned or has been previously pruned. The prune indicator 176 has one value if the weight is unpruned (e.g., the bit is set and has a value of one), and a different value if the weight has been previously pruned (e.g., the bit is cleared and has a value of zero). As described below, a pruned weight also has a value of zero; when a weight is pruned, its value is set to zero. The value of the prune indicator 176 is determined by the pruning hardware unit 190, as described further below.

In embodiments, the computing system 170 (specifically, the training engine 150) communicates with the pruning hardware unit 190 via an application programming interface (API) 180. The API 180 may be implemented on the computing system 170 or on the pruning hardware unit 190. In embodiments, the API 180 is a software interface; however, the disclosure is not so limited. For example, the functionality provided by the API 180 can instead be provided by a hardware controller.

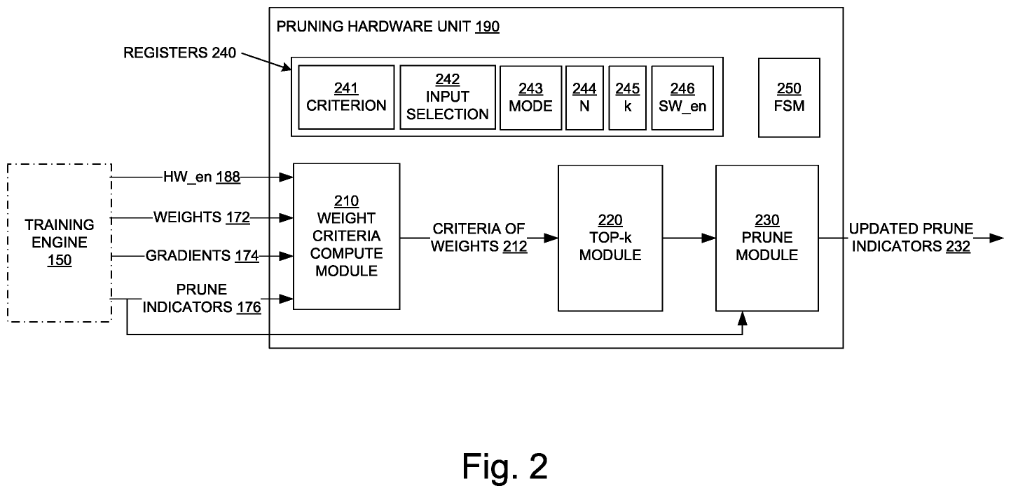

FIG. 2 is a block diagram illustrating the pruning hardware unit 190 in embodiments according to the present disclosure. In general, the pruning hardware unit 190 includes modules 210, 220, and 230 controlled by a controller 250. The pruning hardware unit 190 is configured to: receive, from the training engine 150, inputs including the weights 172, gradients 174, and a prune indicator 176 per weight; select unpruned weights for pruning; prune the unpruned weights selected for pruning; update the prune indicator per weight for the weights that are selected and pruned; and provide the updated prune indicator per weight to the training engine 150.

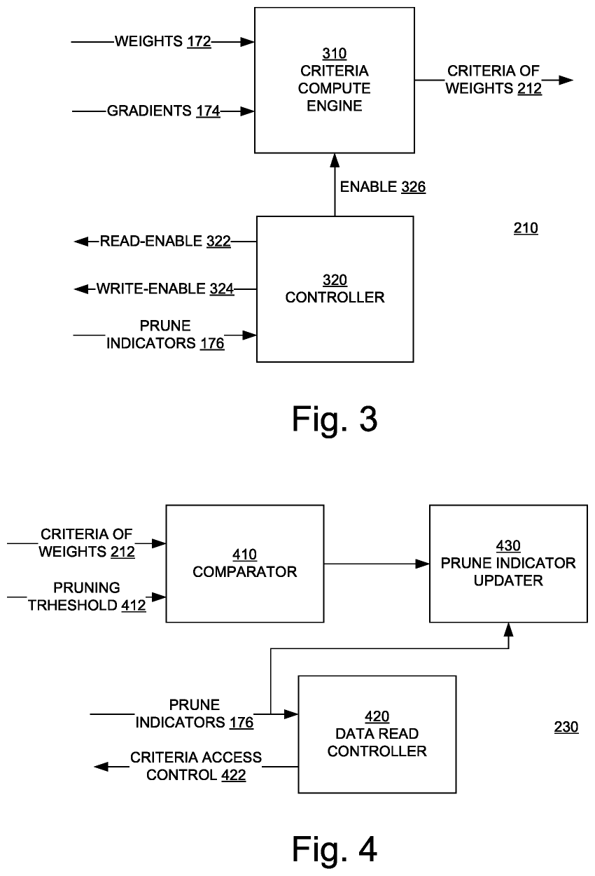

In some embodiments, the weight criteria compute module 210 may receive the aforementioned inputs from the training engine 150, and output criteria of weights 212 for the unpruned weights only. That is, the weight criteria compute module 210 does not operate on or use pruned weights. As mentioned above, the value of the prune indicator 176 indicates whether the weight is a pruned weight or an unpruned weight. The weight criteria compute module 210 is further described in conjunction with FIG. 3.

Continuing with reference to FIG. 2, the weight criteria compute module 210 supports computation of different criteria of weights 212. The criteria of weights 212 may be the criteria used by the training algorithm used by the training engine 150 to minimize the objective (loss) function, for example. The criteria of weights 212 may be the magnitudes (absolute values) of the unpruned weights, for example. In general, the criteria of weights 212 are used to indicate the relative importance of the weights that are output by the weight criteria compute module 210.

The top-k module 220 computes a value of a pruning threshold based on the criteria of weights 212 that are received from the weight criteria compute module 210. The pruning threshold is used to select unpruned weights for pruning, as will be described further below.

The prune module 230 updates the values of each prune indicator 176 based on the results from the top-k module 220. The values of unpruned weights that are selected for pruning are set to zero, and the values of pruned weights remain at zero for the remainder of the training process. Consequently, for the remainder of the training process, the values of the pruned weights are not updated, their gradients are not computed, and multiplications using pruned weights are no longer performed, thus reducing the amount of computational and storage resources and time required to train a neural network.

The prune module 230 outputs updated prune indicators 232, which are used as the inputs to the training engine 150 and the weight criteria compute module 210 in the next iteration or epoch. The prune module 230 is further described in conjunction with FIG. 4.

The controller 250 of FIG. 2 updates values used by the training engine 150 based on the outputs of the prune module 230. In an embodiment, the controller 250 is a finite-state machine (FSM) controller.

In embodiments, the pruning hardware unit 190 includes a number of registers 240. In an embodiment, the registers include a criterion register 241, an input selection register 242, a mode register 243, an N register 244, a k register 245, and a software-enable (SW_en) register 246. The registers 240 are configured by the training engine 150, and written to by the API 180 (FIG. 1).

The pruning hardware unit 190 of FIG. 2 is enabled when both a hardware-enable (HW_en) signal 188 from the training engine 150 and the value in the software-enable register 246 are valid.

The value (instruction) in the criterion register 241 defines the criteria to be used to prune unpruned weights. The value in the input selection register 242 identifies the criteria (e.g., weights and gradients) to take from the training engine 150.

The value in the mode register 243 defines the pruning mode. In embodiments, there is an incremental pruning mode and a non-incremental pruning mode. In the incremental pruning mode, the fraction (or percentage) of the weights that are pruned increases as the training process advances. For example, in an earlier epoch or iteration, 10 percent of the weights may be pruned; in a later epoch or iteration, 20 percent of the remaining weights may be pruned; and so on. In the non-incremental mode, the fraction of weights that are pruned per epoch or iteration is constant (e.g., always 10 percent).

The value in the N register 244 is the number N of unpruned weights. Initially, the value of N is the total number of weights. As weights are pruned, the number of unpruned weights decreases, and the value of N is updated accordingly.

The value in the k register 245 is the number of weights that are not to be pruned in the current iteration or epoch. That is, the value in the k register 245 establishes the pruning threshold used by the top-k module 220. For example, when the weights that are output from the weight criteria compute module 210 are ranked according to the criterion of weights 212 (e.g., in order from highest to lowest), the top k weights are not pruned, while the weights other than the top k weights are pruned.

In operation, if the value of N in the N register 244 is zero, meaning that the API 180 is being called for the first time, then the value of N is reset to the total number of weights 172, and the value of k in the k register 245 is set to the product of N and one minus the sparsity value (1−<sparsity value>). The target sparsity value defines the fraction of the total weights that are to be pruned. In an embodiment, the sparsity value is a user-specified value (e.g., a user-defined input to the training engine 150 or API 180).

The API 180 (or hardware controller) determines the prune mode (e.g., incremental or non-incremental) and sets the mode register 243 accordingly. In the incremental mode, after each iteration or epoch, the value of N in the N register 244 is updated to the current value of k in the k register 245, and the value of k in the k register 245 is then updated as the product of the current value of N and one minus the sparsity value.

In the non-incremental mode, after each iteration or epoch, the value of N in the N register 244 remains the same, and so the value of k in the k register 245 (the product of the current value of N and one minus the sparsity value) also remains the same.

At the beginning of each iteration or epoch, the API 180 (or the hardware controller) determines the inputs required to compute the criteria of weights 212, and sets the input selection register 242 accordingly. After each iteration or epoch, the API 180 or hardware controller sets (updates) the values in the registers 240 as needed based on the results of the just-completed iteration or epoch and/or to set up the next iteration or epoch.

FIG. 3 is a block diagram illustrating the weight criteria compute module 210 in embodiments according to the present disclosure. In the FIG. 3 embodiments, the weight criteria compute module 210 includes two sub-modules: a criteria compute engine 310, and a controller 320.

When the pruning hardware unit 190 (FIG. 2) is operating in the incremental mode, the controller 320 provides an enable signal 326 to the criteria compute engine 310. The value of the enable signal 326 (valid or invalid) depends on the value of the prune indicator 176: the enable signal is valid when the prune indicator 176 indicates that the weight 172 is unpruned. When the pruning hardware unit 190 is operating in the non-incremental mode, the enable signal 326 is always valid.

Continuing with reference to FIG. 3, the weights 172 and gradients 174 are selected and input to the criteria compute engine 310 according to the values of the weight read-enable signal 322 and the gradient read-enable signal 324. The values (valid or invalid) of the weight read-enable signal 322 and the gradient read-enable signal 324 are set according to the value in the input selection register 242 (FIG. 2).

The criteria compute engine 310 of FIG. 3 outputs the criteria of weights 212 to the top-k module 220 (FIG. 2).

FIG. 4 is a block diagram illustrating the prune module 230 in embodiments according to the present disclosure. In the FIG. 4 embodiments, the prune module 230 includes a comparator 410, a data read controller 420, and a prune indicator updater 430.

The comparator 410 compares the criteria of weights 212 to the pruning threshold 412 generated by the top-k module 220 as described above in conjunction with FIG. 2. The comparator 410 performs the comparison one weight at a time under control of the data read controller 420 of FIG. 4. The comparator 410 does not operate on previously pruned weights. As mentioned previously herein, the value of the prune indicator 176 indicates whether a weight is pruned or unpruned.

The comparator 410 and the prune indicator updater 430 work in a pipelined manner. The data read controller 420 controls whether to read a weight according to the value of the prune indicator 176 associated with that weight. The data read controller 420 uses a criteria access control signal 422 to synchronize the prune indicators 176 and the criteria of weights 212. If a prune indicator 176 indicates that the next weight (the weight associated with that prune indicator) to be processed is pruned, then the data read controller 420 will read the value of that prune indicator but not read the value of the associated weight (the value of the weight is zero). If a prune indicator 176 indicates that the next weight (the weight associated with that prune indicator) to be processed is unpruned, then the data controller 420 will read the prune indicator's value and, based on the criteria access control signal 422, will also read the value of the associated weight, after the prune indicator updater 430 finishes processing of the current weight being processed.

The result of each comparison performed by the comparator 410 is forwarded to the prune indicator updater 430. The prune indicator updater 430 also receives the prune indicator 176 for the weight associated with the comparison result. If the comparison result indicates that an unpruned weight should be pruned, then the prune indicator updater 430 resets the value of the prune indicator 176 for that weight; for example, the prune indicator updater clears the prune indicator bit. The prune indicator updater 430 outputs updated prune indicators 232, which are used as the inputs to the training engine 150 and the weight criteria compute module 210 (FIG. 2) for the next iteration or epoch.

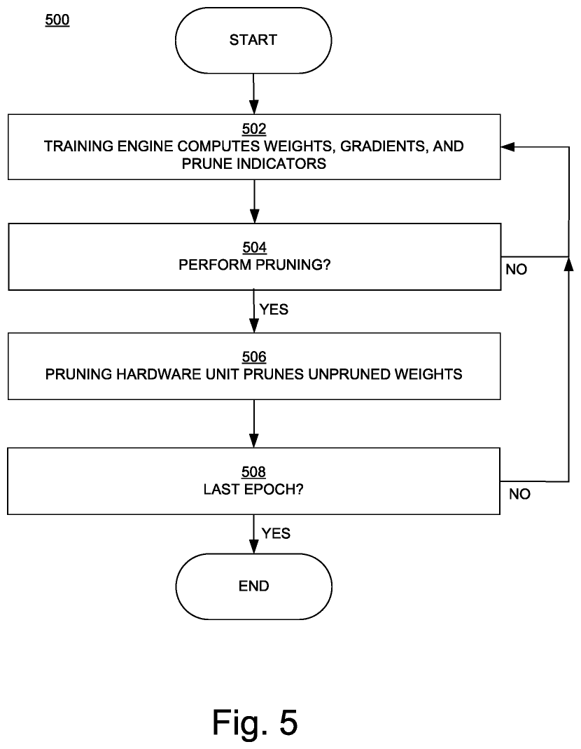

FIG. 5 is a flowchart 500 of a method for training a neural network in embodiments according to the present disclosure. The method is implemented using the system 100 of FIG. 1 as further described in FIGS. 2-4.

In block 502 of FIG. 5, the training engine 150 is used compute weights 172, gradients 174, and prune indicators 176.

In block 504, a determination is made with regard to whether or not pruning is to be performed for the current epoch or iteration. That is, pruning is not necessarily performed during every iteration or epoch. The frequency of pruning can be based on a user input or based on the results of calculations performed by the training engine 150, for example. If pruning is to be performed, then the flowchart 500 proceeds to block 506; otherwise, the flowchart returns to block 502.

In block 506, unpruned weights are pruned by the pruning hardware unit 190 as described above in conjunction with FIGS. 2-4.

In block 508, if the last epoch of the training process has been reached, then the flowchart 500 ends; otherwise, the flowchart returns to block 502.

Using a pruning hardware unit as described above, embodiments according to the disclosure avoid the shortcomings of conventional software-implemented incremental pruning. Thus, embodiments according to the disclosure reduce the amount of computational and storage resources and time required to train neural networks without affecting the accuracy of the neural networks, by careful pruning of data (e.g., weights) during the training process. In various embodiments, the pruning hardware unit may be implemented as a hardware device or system, and the various modules described herein may be implemented as one or more processors coupled to one or more non-transitory computer-readable storage media storing instructions that, when executed by the one or more processors, perform the various operations described above with respect to the modules.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Also, while the foregoing disclosure sets forth various embodiments using specific block diagrams, flowcharts, and examples, each block diagram component, flowchart step, operation, and/or component described and/or illustrated herein may be implemented, individually and/or collectively, using a wide range of configurations. In addition, any disclosure of components contained within other components should be considered as examples because many other architectures can be implemented to achieve the same functionality.

Although the subject matter has been described in language specific to structural features and/or methodological acts, the subject matter defined in the disclosure is not necessarily limited to the specific features or acts described above. Rather, the specific features and acts described above are disclosed as example forms of implementing the disclosure.

Embodiments according to the disclosure are thus described. While the present disclosure has been described in particular embodiments, it should be appreciated that the disclosure should not be construed as limited by such embodiments, but rather construed according to the following claims.

1. An apparatus for training neural networks, the apparatus comprising:
a controller; and
a plurality of registers coupled to the controller;
wherein the apparatus is configured to perform operations comprising:
receiving inputs comprising (i) values of weights for nodes of a neural network and (ii) a value of an indicator of each of the weights, wherein the value of the indicator indicates whether the weight is a pruned weight or an unpruned weight;
selecting, from the weights, unpruned weights for pruning;
pruning the selected unpruned weights;
updating the value of the indicator of each of the weights according to the pruned weights; and
providing the updated value of the indicator of each of the weights to a neural network training engine.

2. The apparatus of claim 1, wherein:
the plurality of registers comprise a register that indicates a pruning mode of a plurality of pruning modes;
the plurality of pruning modes include an incremental pruning mode; and
a fraction of the pruned weights increases as with neural network training.

3. The apparatus of claim 1, wherein pruning the selected unpruned weights comprises setting values of the weights selected for pruning to zero.

4. The apparatus of claim 1, wherein:
the plurality of registers comprise a register that stores a value of a number of unpruned weights and a register that stores a value for selecting the weights for pruning; and
the value for selecting the weights for pruning corresponds to a fraction of the number of unpruned weights.

5. The apparatus of claim 4, wherein the controller is configured to compute the value for selecting the weights for pruning by multiplying the value of the number of unpruned weights and a value based on a target sparsity value.

6. The apparatus of claim 1, wherein the plurality of registers comprise a register that stores a value for selecting the inputs.

7. The apparatus of claim 1, wherein the plurality of registers comprise a register that stores criteria for pruning the weights.

8. A system for training neural networks, the system comprising:
a neural network training engine configured to generate outputs comprising values of weights for nodes of a neural network; and
an apparatus coupled to the neural network training engine via an application programming interface (API), wherein:
the apparatus comprises a controller and a plurality of registers coupled to the controller; and
the apparatus is configured to:
receive the outputs from the training engine;
receive a value of an indicator of each of the weights,
wherein the value of the indicator indicates whether the weight is a pruned weight or an unpruned weight;
select, from the weights, unpruned weights for pruning;
prune the selected unpruned weights;
update the value of the indicator of each of the weights according to the pruned weights; and
provide the updated value of the indicator of each of the weights to a neural network training engine.

9. The system of claim 8, wherein:
the plurality of registers comprise a register that indicates a pruning mode of a plurality of pruning modes;
the plurality of pruning modes include an incremental pruning mode; and
a fraction of the pruned weights increases with neural network training.

10. The system of claim 8, wherein to prune the selected unpruned weights, the apparatus is configured to set the values of the selected unpruned weights to zero.

11. The system of claim 8, wherein:
the plurality of registers comprise a register that stores a value of a number of unpruned weights and a register that stores a value for selecting weights for pruning; and
the value for selecting weights for pruning corresponds to a fraction of the number of unpruned weights.

12. The system of claim 11, wherein the API is configured to determine the value for selecting weights for pruning by multiplying the value of the number of unpruned weights and a value based on a target sparsity value.

13. The system of claim 8, wherein the plurality of registers comprise a register that stores a value for selecting inputs from the outputs of the training engine.

14. The system of claim 8, wherein the plurality of registers comprise a register that stores criteria for pruning the weights.

15. The system of claim 8, wherein the API is configured to write values to the plurality of registers.

16. An apparatus for training neural networks, the apparatus comprising:
a controller; and
a plurality of registers coupled to the controller;
wherein the apparatus is configured to perform operations comprising:
receiving inputs from a neural network training engine, the inputs comprising (i) values of weights for nodes of a neural network and (ii) values of an indicator of each of the weights, wherein the value of the indicator indicates whether the weight is a pruned weight or an unpruned weight;
outputting criteria of weights for unpruned weights;
computing a value of a pruning threshold based on the outputted criteria; and
updating the values of the indicator of each of the weights;
updating values used by the neural network training engine based on the updated values of the indicator of each of the weights.

17. The apparatus of claim 16, wherein:
the plurality of registers comprise a register that indicates a pruning mode of a plurality of pruning modes;
the plurality of pruning modes include an incremental pruning mode; and
a fraction of the pruned weights increases with neural network training.

18. The apparatus of claim 16, wherein:
the plurality of registers comprise a register that stores a value of a number of unpruned weights and a register that stores a value for selecting weights for pruning;
the value for selecting weights for pruning corresponds to a fraction of the number of unpruned weights; and
the apparatus is configured to compare the criteria of weights for unpruned weights and the pruning threshold to select weights for pruning and update the values of the indicator of each of the weights accordingly.

19. The apparatus of claim 16, wherein the plurality of registers comprise a register that stores a value for selecting the inputs.

20. The apparatus of claim 16, wherein the plurality of registers comprise a register that stores criteria for pruning the weights.
